(19) United States
(12) Patent Application Publication
(10) Pub. No.: US 2013/0016586 A1
(43) Pub. Date: Jan. 17, 2013

(54) FISH FINDER WITH SIMPLIFIED CONTROLS

(71) Applicant: DAVID A. CRAIG, Owasso, OK (US)

(72) Inventor: DAVID A. CRAIG, Owasso, OK (US)

(21) Appl. No.: 13/550,336

(22) Filed: Jul. 16, 2012

Related U.S. Application Data
(60) Provisional application No. 61/508,289, filed on Jul. 15, 2011.

(51) Int. Cl. G01S 15/96

(52) U.S. Cl. 367/107

(57) ABSTRACT

A fish finder having a sonar transducer, a sonar receiver, a display unit having a single user control or no user controls. The fish finder has a digital controller within the display unit that has a predetermined set of operational parameters programmed therein. Upon activation of the control, the digital controller operates the sonar transducer and sonar receiver according to the predetermined operational parameters.

### CROSS REFERENCE TO RELATED APPLICATIONS

This application claims the priority of U.S. Provisional Patent Application No. 61/508,289 entitled “INTELLIGENT FISH FINDER,” filed Jul. 15, 2011, the contents of which are hereby incorporated by reference.

### FIELD OF THE INVENTION

This disclosure relates to fishing sports in general and, more particularly, to electronic fish finding.

### BACKGROUND OF THE INVENTION

There are many digital, graphing display fish finders in the marketplace and most offer a large number of settings and options selectable by the user. However, not all of the available settings are optimal even if they are selectable by the user. It is possible for a user to specify suboptimal parameters for the operation of the fish finder which can result in dissatisfaction with the product, even when it is working as intended.

What is needed is a system and method for dealing with the above, and related problems.

### SUMMARY OF THE INVENTION

The invention of the present disclosure, in one embodiment thereof, comprises a fish finder having a sonar transducer, a sonar receiver, a display unit having a single user control. The fish finder has a digital controller within the display unit that has a predetermined set of operational parameters programmed therein. Upon activation of the control, the digital controller operates the sonar transducer and sonar receiver according to the predetermined operational parameters. In some embodiments, upon a second activation of the control, the digital controller ceases operation of the sonar transducer and sonar receiver.

The fish finder may also comprise a video display affixed to the display unit that receives video display information from the digital controller as detected by return echo from the sonar transducer by the sonar receiver and displays the information. Some embodiments have an environmental condition sensor providing information to the digital controller for use in operating the sonar transducer and sonar receiver.

In some embodiments, the digital controller adjusts a power output of the sonar transducer and keeps a sensitivity of the sonar receiver at a constant level. The digital controller may increase the power signal to the power amplifier in response to loss of a predetermined level of return sonar echo being detected by the sonar receiver

The invention of the present disclosure, in another aspect thereof, comprises a fish finder having a display unit with a display screen, a digital controller communicatively coupled to the display screen, and a power amplifier receiving power signals from the digital controller. The fish finder has sonar transducer for transmitting sonar signals into water in response to electrical power from the power amplifier, and a sonar receiver for receiving return echo sonar signals from the water. The digital controller receives return echo signals from the sonar receiver and displays corresponding graphical information to the display screen. The digital controller operates the display screen, the power amplifier, and the sonar receiver based on preprogrammed parameters with no input from a user. In some embodiments, there are no user accessible controls. In other embodiments, only a single user control is provided for activating the fish finder. The single user control may comprise a button that is activated by a long press to activate or deactivate the fish finder, and may be activated by short presses to cycle through a brightness setting level of the display screen. In other embodiments, the digital controller operates the display screen, the power amplifier, and the sonar receiver automatically upon receiving power. The fish finder may have an environmental condition sensor providing information to the digital controller for use in operating the power amplifier and the sonar receiver.

In some embodiments, the digital controller alters the power output of the sonar transducer in response to a state of return echo signals received or not received by the sonar receiver. The alteration of power output may occur in real time.

The invention of the present disclosure, in another embodiment thereof, comprises a method including providing a digital controller with an output signal to a power amplifier; providing a sonar transducer powered by the power amplifier; and providing a sonar receiver communicatively coupled to the digital controller. The method includes operating the power amplifier and sonar receiver based upon predetermined parameters contained in the digital controller without input from a user.

In some embodiments, the method includes adjusting the output signal to the power amplifier such that return echo noise detected by the sonar receiver is below a predetermined threshold. In some embodiments, a single user control may be provided that allows for activation of the digital controller but no alteration of the predetermined parameters. The method may include providing an environmental condition sensor that provides information to the digital controller for use in operating the power amplifier and sonar receiver.

### BRIEF DESCRIPTION OF DRAWINGS

FIG. 1A is a schematic diagram of a fish finding sonar system.

FIG. 1B is a schematic diagram of another fish finding sonar system.

FIG. 2 is an environmental view of the fish finding sonar system of FIG. 1A mounted for use on a boat.

FIG. 3 is a block diagram of a fish finding sonar system with communication and control channels illustrating an operational mode with fixed power output.

FIG. 4 is a block diagram of a fish finding sonar system with communication and control channels illustrating an operational mode with adjustable power output.

FIG. 5 is a flow chart illustrating a power feedback mechanism for a fish finding sonar system according to aspects of the present disclosure.

### DETAILED DESCRIPTION OF THE PREFERRED EMBODIMENTS

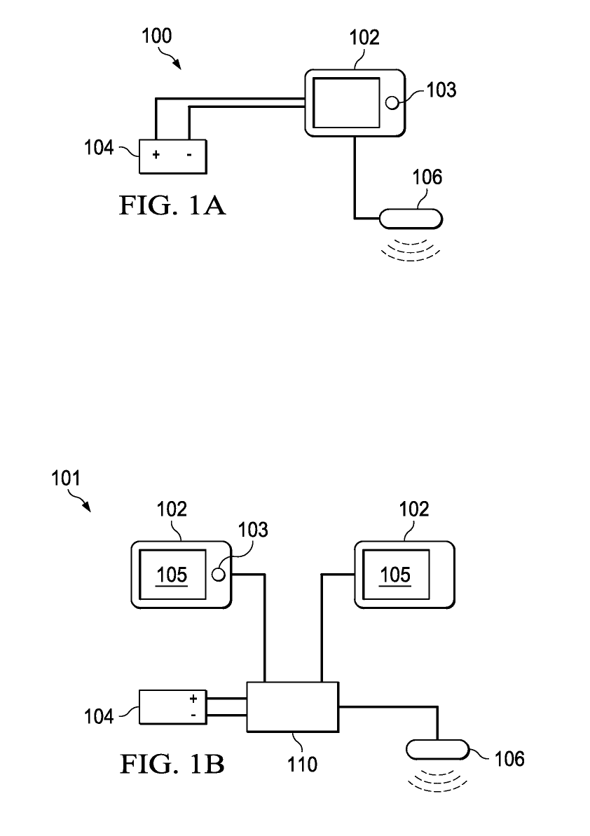

Referring now to FIG. 1A, a schematic diagram of a fish finding sonar device is shown. Sonars utilized for purposes of locating fish below the surface of the water are often referred to as “fish finders.” The fish finder system 100 of FIG. 1A comprises a display and processing unit 102. The unit 102 is the physical housing that contains most of the operational electronics of the system 100. In the present embodiment, the display unit 102 also provides at least one display screen 105 and a single user control 103. In some embodiments, the system 100 automatically adjusts all operational parameters such that the control 103 is used only to activate the system 100. In other embodiments, very limited additional functionality may be provided through the control 103. For example, if the control 103 is a button, a long press may power on or off, while a short press may adjust brightness of the display screen 105. In some embodiments, the display screen 105 functions as an input device (e.g., it may be capacitive or pressure sensitive) such that the separate control 103 is not needed. In other embodiments, once the system 100 is powered on (e.g., connected to a power source) it may immediately begin operating as described herein. In such an embodiment, any type of separate user control is unneeded.

It is understood that in embodiments providing a user control 103, the control may take a plurality of different forms. For example, the control 103 may be a button, a pressure sensor, a switch, a knob, a lever, a slider, or other control. The control may be made waterproof, or water or weather resistant as needed. Further, only having a single control can reduce manufacturing costs and result in greater water resistance of integrity of the display unit 102.

The display unit 102 is powered by an electrical power supply 104. In some embodiments, the power supply 104 comprises a battery that may be located on a boat. The display unit may attach to the battery 104 via direct wiring, an auxiliary or power outlet (not shown), or other means. In other embodiments, the power supply 104 may actually be internal to the display unit 102 to allow operation when an outside power supply is not available. In such embodiments, an electrical connection may be provided for recharging of the power supply 104 from the boat, or a land-based electrical outlet.

The display unit 102 is also communicatively coupled to transducer 106. The coupling provides for power and/or electronic communications between the transducer and the display unit. In some embodiments, the transducer 106 acts as both a sonar emitter and a sonar detector. The transducer 106 may be a piezoelectric device that emits a sonar pulse in response to being electrically energized by the display unit 102. The transducer 106 will produce a corresponding voltage as a result of absorbing reflected energy from within the water. This information is utilized by the display unit 102 to display information to a user. The information may include bottom depth, fish location, and other information.

It will be appreciated that it is possible to provide a great deal of user control over the operational parameters of the system 100. For example, it is possible to allow a user to control the sonar beam angle, power output, screen contrast, screen color, sensitivity, zoom, and a host of other display information pertaining to the way that objects are displayed. However, when such controls are provided, a great number of users will never alter the system from the default settings. Furthermore, not all available settings are optimal. It is possible or even likely that a user will either select a worse set of parameters than the default, or that the improvement resulting from settings adjustments is marginal. Either of these outcomes can result in a diminished user experience. Fortunately, a set of default parameters may be chosen that covers the majority of conditions and uses for the system 100. The system 100 may thus be activated or powered on with the single control 103 and the user will be provided with a sonar or fish finder system that is capable of operating satisfactorily over the vast majority of conditions encountered by most users. In other embodiments, the system 100 is powered on by being connected to a power supply (e.g., by accessory key) and the control 103 is not needed at all.

Referring now to FIG. 1B, a schematic diagram of another fish finding sonar system 101 is shown. The operation of the system 101 is substantially similar to that of FIG. 1A. It will be appreciated that the control functions and methods described below will function equally well with the system 101 of FIG. 1B. The system 101 provides a sonar module 110 that may contain all or part of the operational electronics needed by the system 101. In some embodiments, the sonar module 110 connects to the power supply 104. The sonar module is coupled to the transducer/receiver 106 and may connect to multiple display units 102, each having a screen 105. Here, one display unit is shown with a single control 103. It will be appreciated that this configuration is meant to be illustrative rather than limiting as in some embodiments each display unit 105 may have a control, or neither may have a control.

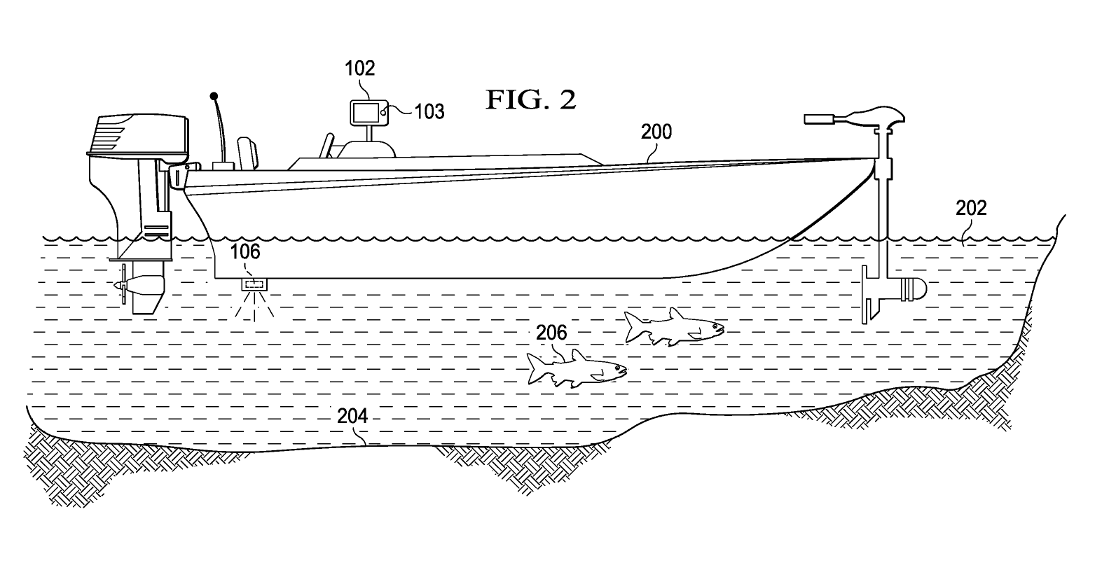

Referring now to FIG. 2, an environmental view of the fish finding sonar system of FIG. 1A mounted for use on a boat is shown. It should be understood that FIG. 2 is not to scale nor necessarily indicative of the full range of terrain and fish that the system may be able to detect. The display unit 102 may be mounted in a convenient, use accessible location on a boat 200. The boat 200 may be a personal sized fishing boat or kayak, or may be capable of supporting multiple fishermen, or even a large commercial setup. It will be appreciated that when the system 100 is configured for operation on a boat 200 it may be wired to the ignition system of the boat 200 such that it becomes operational upon turning the key on (e.g., similar to a gauge, radio, or other accessory keyed device).

In some embodiments, the transducer 106 will be mounted below the structure of the boat 200, beneath the surface of the water 202. In other embodiments, the transducer may not actually be in the water (e.g., it could be within the boat hull 200). The transducer 106 emits sonic waves (sonar) into the water and detects return echoes from the water boundaries such as the surface 202 and/or ground 204. Receiving return echoes from water boundaries may be important for determining the location and depth of the ground 204, for example. However, as explained in further detail below, when the boundaries are detected multiple times, it may be that more sonar energy than needed is being utilized. Excess or multiple return echoes from the same water boundary may be considered “noise” that must be addressed or accounted for by the sonar system 100 automatically—particularly in embodiments where only a single user control is utilized. Importantly, the transducer 106 and system 100 also detect fish 206, and/or other subsurface structures.

In some embodiments, the parameters that the system 100 operates under may be tailored to the location in which the unit is sold. For example, in areas where mostly shallow bodies of water are encountered the parameters may be optimized for finding fish in shallow water. Where deeper bodies of water are encountered, the parameters may be optimized for deep water. However, as described below, power output and/or sensitivity of the transducer and receiver may be adjusted automatically by the unit 100 itself. In this way, the system 100 may function in a wider array of conditions while retaining the simplicity of the single control 103.

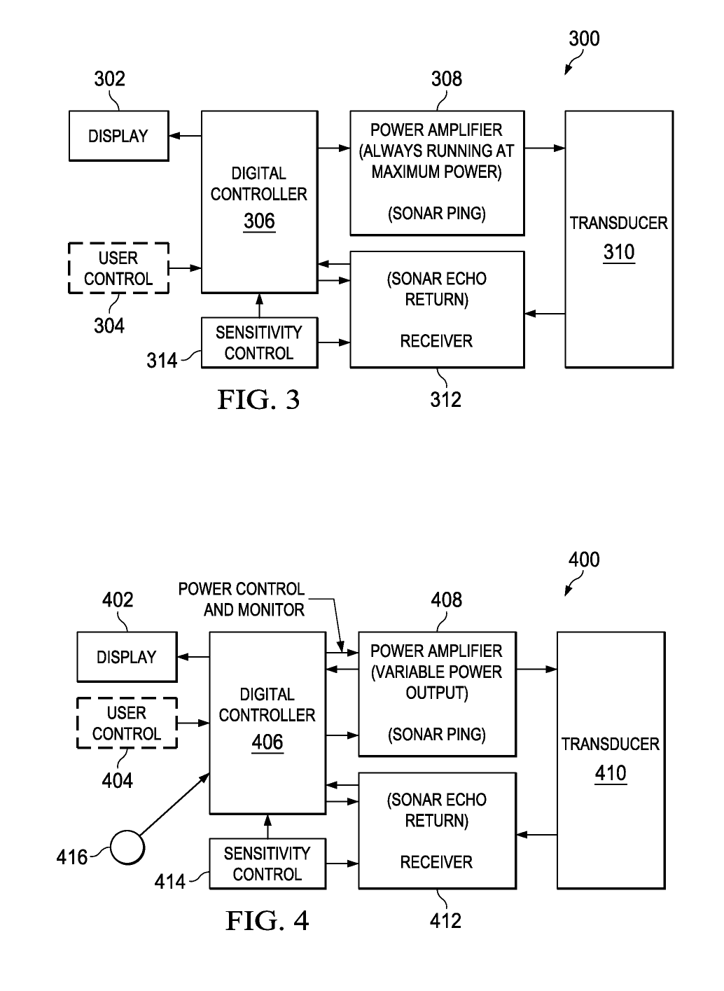

Referring now to FIG. 3, is a block diagram of a fish finding sonar system with communication and control channels illustrating an operational mode with fixed power output is shown. The system 300 comprises a display receiving data from a digital controller 306. The controller may accept input from a single user control 304 (if any control is provided). The controller 306, display 302, and control 304 may be integral with the display unit (102, FIG. 1A). In some embodiments, the digital controller 306 is a solid state device and may be at least partially programmable. The controller 306 provides control signals to a power amplifier 308 that may also be incased in the display unit 102. The amplifier 308 may be based on an integrated circuit and provide the appropriate voltage and current for driving the transducer 310 (shown as 106 in FIGS. 1A, 1B, and 2).

The transducer 310, relying on power from the amplifier 308, emits sonar waves or signals into the water. The echo or echoes from the sonar signal is received by the receiver 312. Although shown here as a separate logical component, in some embodiments, the transducer 310 and the receiver 312 may be housed in the same housing, or may even be the same piezoelectric component (as described above with respect to FIG. 1A).

In the present embodiment, a high intensity ping is produced from the transducer 310 into the water when powered on. In other words, the power amplifier 308 is driven at or near its maximum. Since depth is unknown when the device 300 is powered up, a high intensity ping will ensure that the bottom is reached and detected by the fish finder receiver 312. However, in the event that the fish finder 300 is operating in shallow water, the return signal (echo) will be quite intense. It may be detected multiple times by the receiving transducer 312 as it bounces between the bottom and the water/air boundary. The signal will also contain a lot of noise. In such a system 300, the sensitivity of the receiver 312 may be turned down to avoid multiple return echoes from the same ping, and to reduce the noise in the signal which would be detrimental to an accurate display reading. This relationship is shown logically by the sensitivity control setting 314. Physically, the sensitivity control 314 will be implemented by the digital controller 306 integrated into the display unit 102.

Stated another way, the greater the output power of the fish finder 300, the deeper the fish finder 300 will track the bottom, and track fish. However, the greater the power, the more energy is being placed into the water and as the depth gets shallower, the fish finder 300 may actually be putting too much energy into the water. This extra energy may be seen as noise by the receiver 312 and has to be overcome. Reduction of the receiver/input sensitivity is one way to handle this.

Referring now to FIG. 4, a block diagram of a fish finding sonar system with communication and control channels illustrating an operational mode with adjustable power output is shown. The system 400 provides a digital controller 406 with a display 402 and a single control 404 (or no control). Here again, these components may be integrated into the display unit 102 (FIG. 1A). A power amplifier 408 is controlled by the controller 406 to provide the appropriate voltage and current to drive the transducer 410. Sonar waves are produced and the echoes are detected by the receiver 412. Again, the transducer 410 and receiver 412 may be integrated wholly, or at least share a housing. The return echo signals are provided to the digital controller for processing and display on the display 402. Once again, sensitivity control 414 may be provided, and may be part of the digital controller 412.

In some embodiments, such as that shown in FIG. 4, rather than reducing the sensitivity of the receiver 412, the power output of the transducer 408 is reduced. Power control and monitoring of the power amplifier 408 by the digital controller 406 may be achieved as illustrated by the two-way communication path shown in FIG. 4. In this manner, when a high intensity ping is needed (e.g., in deep water) it may be provided based upon feedback from the receiver 412. However, in conditions where the ping is producing a lot of noise in the echo, the transducer 410 may be operated at a lower level. By operating the transducer 410 at the lowest level capable of providing an adequate return signal, noise is avoided. Furthermore, the display resolution and quality for the user improves.

The digital controller 406 logic of the fish finder 400 may automatically adjust the power output, possibly according to feedback from the receiver 412. In some embodiments, the power output is controlled by varying the power amplifier 408 section of the fish finder's 400 circuitry. This may be done by programmable hardware and/or software routines executed in the digital controller 406 and/or other components.

In some embodiments of the fish finder 400, as the device moves into shallower water, output power is reduced so that sensitivity can stay at maximum. This will allow more detail to be detected by the receiver 412, which may be operated at or near maximum sensitivity. This, in turn, allows more detail and information to be displayed for the user on the display 402. In some embodiments, the current power output and/or sensitivity may be displayed to the user as well. There will be numerous ways within the purview of one of skill in the art in which the power output of the transducer 410 can be varied. The present disclosure is not intended to be limited to particular circuitry.

Some embodiments will provide one or more environmental condition sensors 416 that provide information to the digital controller 406. The environmental condition sensor 416 may include, but it not limited to an air or water temperature sensor, a light level sensor, a speed sensor (e.g., connected to the watercraft) and an inertial movement sensor. Such sensors may be used to inform the digital controller of particular conditions that may be taken into account in its operation of the system 400. The sensor 406 may be remote from the controller 406 (e.g., in the case of a water temperature sensor), but may also be integrated into the same housing (e.g., in the case of an air temperature or movement sensor). By relying on one or more sensor 416, the controller can further adapt the operational parameters of the system 400 to the current conditions and/or environment without need for input from the user. For example, display levels, resolutions, brightness and other settings may all be controlled based on feedback from sensors, instead of, or in addition to, predetermined settings. Even when connected to power, inertial switches or other mechanisms may be used to indicate to the microcontroller 406 when the fish finder is no longer being used. This will allow the fish finder to enter a lower power saving state to prevent drain on the external battery or other power supply. As described above, in other embodiments, the system 400 may power off with an accessory/ignition switch.

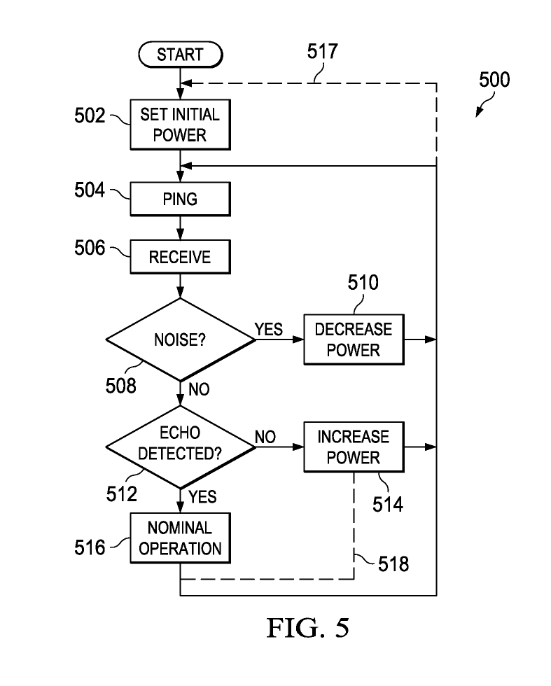

Referring now to FIG. 5, a flow chart illustrating a power feedback mechanism for a fish finding sonar system according to aspects of the present disclosure is shown. In order to ensure that power output is maintained at an appropriate level, a feedback mechanism may be employed. The feedback and adjustment of power output may occur in real time, such that a user does not have to be involved. The initial power for the amplifier 408 and transducer 400 may be set at startup at step 502. In some embodiments, this will be a high power setting to produce a ping at step 504 that is certain to detect the bottom. In such cases, a large echo may be received at step 506 that is indicative of the bottom floor of the body of water. The echo, if of sufficient magnitude, can rebound off the surface of the water where it meets the air. This can create another readable echo on the transducer that becomes noise (e.g., because it is not indicative of an actual structure in the water). With sufficient power remaining in the ping, it can travel to the bottom and be reflected and detected yet again. This cycle can repeat a number of times and still be detectable by the transducer, particularly if a high strength ping is used in shallower waters. The logic of the digital controller 406 may detect such noise at step 508.

If unacceptable noise is detected at step 508, power may be decreased at step 510 and the ping repeated at step 504. In order to avoid having the secondary echoes display on the fish finder 400, the magnitude of the output is reduced until noise and unwanted secondary echoes are avoided. If, after a time, or even at startup, no echo is detected at step 512, power can be increased at step 514. In some embodiments, particularly where the power setting is initially set to maximum, the power level may be returned to its initial setting by proceeding back to step 502 from step 514 as shown by dotted line 516. In effect, this results in the digital controller 406 continuously monitoring the return signal from the receiver 412 to ensure that the signal is powerful enough to be useful, but not so powerful as to produce unacceptable noise. The levels may be programmed with a built in hysteresis to prevent continual adjustment of the power level. In other words, an acceptable range of nominal operation may be achieved (step 516) where the signal is neither being increased, nor decreased.

It is understood that “nominal operation” here refers to a state where pings are regularly being produced in order to receive usable information from the receiver 412. During nominal operation, the digital controller may continue to monitor for noise (e.g., step 508) so that power can be reduced if and when noise is detected. After a predetermined period of nominal operation, a power increase may be attempted as shown by dotted line 518. Thus, if the boat has moved, or conditions have otherwise changed that would allow for a higher power output without unacceptable noise, power will be increased. Modern integrated circuitry that may be used to implement the digital controller 406 operates at sufficient speed that the aforementioned adjustments may occur without the user taking notice.

In other embodiments, the digital controller 406 may be programmed to operate the power output such that a primary ground return echo of a predetermined strength is received. The predetermined strength may be chosen such that no secondary or noise echoes are produced, yet the output of the transducer 410 remains high enough that good resolution of deep objects is achieved (e.g., steps 508 and 512). When deeper or shallower water is encountered, power may be adjusted accordingly. Similarly, when travelling and higher power is needed to maintain resolution, the digital controller 406 can increase power while in motion and decrease power when the craft slows.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

1. A fish finder comprising:
a sonar transducer;
a sonar receiver;
a display unit having a single user control; and
a digital controller within the display unit and having a predetermined set of operational parameters programmed therein;
wherein upon activation of the control the digital controller operates the sonar transducer and sonar receiver according to the predetermined operational parameters.

2. The fish finder of claim 1, wherein upon a second activation of the control, the digital controller ceases operation of the sonar transducer and sonar receiver.

3. The fish finder of claim 1, further comprising a video display affixed to the display unit that receives video display information from the digital controller as detected by return echo from the sonar transducer by the sonar receiver and displays the information.

4. The fish finder of claim 1, further comprising an environmental condition sensor providing information to the digital controller for use in operating the sonar transducer and sonar receiver.

5. (not entered)

6. The fish finder of claim 1, wherein the digital controller adjusts a power output of the sonar transducer and keeps a sensitivity of the sonar receiver at a constant level.

7. The fish finder of claim 6, wherein the digital controller increases the power signal to the power amplifier in response to loss of a predetermined level of return sonar echo being detected by the sonar receiver

8. A fish finder comprising:
a display unit having a display screen, a digital controller communicatively coupled to the display screen, and a power amplifier receiving power signals from the digital controller;
a sonar transducer for transmitting sonar signals into water in response to electrical power from the power amplifier; and
a sonar receiver for receiving return echo sonar signals from the water;
wherein the digital controller receives return echo signals from the sonar receiver and displays corresponding graphical information to the display screen; and
wherein the digital controller operates the display screen, the power amplifier, and the sonar receiver based on preprogrammed parameters with no input from a user.

9. The fish finder of claim 8, wherein there are no user accessible controls.

10. The fish finder of claim 8 wherein only a single user control is provided for activating the fish finder.

11. The fish finder of claim 10, wherein the single user control is a button that may be activated by a long press to activate or deactivate the fish finder and may be activated by short presses to cycle through a brightness setting level of the display screen.

12. The fish finder of claim 8, wherein the digital controller operates the display screen, the power amplifier, and the sonar receiver automatically upon receiving power.

13. The fish finder of claim 8, wherein the digital controller operates the display screen, the power amplifier, and the sonar receiver automatically upon activation of an associated boat accessory switch.

14. The fish finder of claim 8, further comprising an environmental condition sensor providing information to the digital controller for use in operating the power amplifier and the sonar receiver.

15. The fish finder of claim 8, wherein the digital controller alters the power output of the sonar transducer in response to a state of return echo signals received or not received by the sonar receiver.

16. The fish finder of claim 15, wherein the digital controller alters the power output of the sonar transducer in real time.

17. A method comprising:
providing a digital controller with an output signal to a power amplifier;
providing a sonar transducer powered by the power amplifier;
providing a sonar receiver communicatively coupled to the digital controller; and
operating the power amplifier and sonar receiver based upon predetermined parameters contained in the digital controller without input from a user.

18. The method of claim 17, further comprising adjusting the output signal to the power amplifier such that return echo noise detected by the sonar receiver is below a predetermined threshold.

19. The method of claim 17, further comprising providing a single user control that allows for activation of the digital controller but no alteration of the predetermined parameters.

20. The method of claim 17, further comprising providing an environmental condition sensor that provides information to the digital controller for use in operating the power amplifier and sonar receiver.
